(19) United States
(12) Patent Application Publication
(10) Pub. No.: US 2018/0128206 A1
(43) Pub. Date: May 10, 2018

(54) GAS TURBINE ENGINE

(71) Applicant: General Electric Company, Schenectady, NY (US)

(72) Inventors: Richard David Cedar, Montgomery, OH (US); David Baker Riddle, Cincinnati, OH (US); Alan Roy Stuart, Cincinnati, OH (US); Jeffrey Donald Clements, Mason, OH (US)

(21) Appl. No.: 15/347,301

(22) Filed: Nov. 9, 2016

(51) Int. Cl. F02K 1/72

(52) U.S. Cl. CPC F02K 1/72; F02K 3/06

(57) ABSTRACT

A turbofan engine is provided having a fan and a nacelle assembly enclosing the fan. The nacelle assembly includes a thrust reverser system having one or more cascade segments configured to translate at least partially along an axial direction of the turbofan engine. The turbofan engine further includes a core operable with the fan and at least partially enclosed by the nacelle. The core includes a turbine section having a low pressure turbine defining an exit diameter. A ratio of the exit diameter of the low pressure turbine to a fan diameter of the fan is less than 0.5, providing for a more compact turbofan engine.

### FIELD

The present subject matter relates generally to a gas turbine engine, and more specifically to a gas turbine engine having a relatively compact axial configuration.

### BACKGROUND

Turbofan engines generally include a fan and a core arranged in flow communication with one another. The core of the turbofan engine generally includes, in serial flow order, a compression section, a combustion section, a turbine section, and an exhaust section. In operation, the air provided to the core flows through the compression section where one or more axial compressors progressively compress the air until it reaches the combustion section. Fuel is mixed with the compressed air and burned within the combustion section to provide combustion gases. The combustion gases are routed from the combustion section to the turbine section. The flow of combustion gasses through the turbine section drives the turbine section and is then routed through the exhaust section, e.g., to atmosphere.

For dual spool turbofan engines, the turbine section includes a low pressure turbine and a high pressure turbine, and the compression section includes a low pressure compressor and a high pressure compressor. The high pressure compressor is coupled to and driven by the high pressure turbine, and the low pressure compressor is coupled to and driven by the low pressure turbine. For high power class turbofan engines, each of the compressors and turbines generally include a relatively large number of stages of rotor blades to ensure a desire compression of an airflow is achieved (i.e., within the compressor section), or to ensure a desired amount of energy is extracted from the airflow (i.e., within the turbine section).

However, these relatively large power class turbofan engines are generally heavy and large. Accordingly, one or more features to reduce a weight and/or length for a large power class turbofan engine would be useful.

### BRIEF DESCRIPTION

Aspects and advantages of the invention will be set forth in part in the following description, or may be obvious from the description, or may be learned through practice of the invention.

In one exemplary aspect of the present disclosure, a gas turbine engine defining an axial direction is provided. The gas turbine engine includes a fan defining a fan diameter. The gas turbine engine also includes a nacelle assembly enclosing the fan and including a thrust reverser system. The thrust reverser system includes one or more cascade segments configured to translate at least partially along the axial direction of the gas turbine engine. The gas turbine engine also includes a core operable with the fan and at least partially enclosed by the nacelle. The core includes a turbine section, the turbine section including a high pressure turbine and a low pressure turbine. The low pressure turbine defines an exit diameter. A ratio of the exit diameter of the low pressure turbine to the fan diameter of the fan is less than 0.5.

In another exemplary embodiment of the present disclosure, a gas turbine engine defining an axial direction is provided. The gas turbine engine includes a fan having a plurality of fan blades and defining a fan diameter. The gas turbine engine also includes a nacelle assembly enclosing the fan and including a thrust reverser system. The thrust reverser system includes one or more cascade segments configured to translate at least partially along the axial direction of the gas turbine engine. The gas turbine engine also includes a core operable with the fan and at least partially enclosed by the nacelle. The core includes a low pressure turbine having an aft-most stage of rotor blades. The gas turbine engine defines a turbomachinery length from the fan blades of the fan to the aft-most stage of rotor blades of the low pressure turbine. A ratio of the turbomachinery length to the fan diameter is less than 1.5.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic cross-sectional view of an exemplary gas turbine engine according to various embodiments of the present subject matter.

FIG. 2 is a perspective view of an exemplary turbofan engine according to another exemplary embodiment of the present disclosure having a thrust reverser system in a fully deployed position.

FIG. 3 is an axial, side, sectional view of the exemplary turbofan engine of FIG. 2 depicting the thrust reverser system in a fully stowed position and in a fully deployed position in the upper and lower halves of the view, respectively.

FIG. 4 is an axial, side, sectional view of a turbofan engine in accordance with another exemplary embodiment of the present disclosure depicting the thrust reverser system in a fully stowed position and in a fully deployed position in the upper and lower halves of the view, respectively.

FIG. 5 is a close-up, schematic view of a low pressure turbine of the exemplary gas turbine engine of FIG. 1, in accordance with an exemplary embodiment of the present disclosure.

### DETAILED DESCRIPTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows.

The present application is directed generally towards a gas turbine engine including a translating cascade thrust reverser (e.g., stowed over a fan case of the gas turbine engine and translating along an axial direction to be deployed) in combination with a compact low pressure turbine (i.e., an axially compact low pressure turbine). The inventors of the present disclosure have discovered that such a configuration allows for a shorter (i.e., axially shorter) nacelle, allowing the engine to be installed on an aircraft wing in a manner that results in an overall lighter engine with less drag during operation.

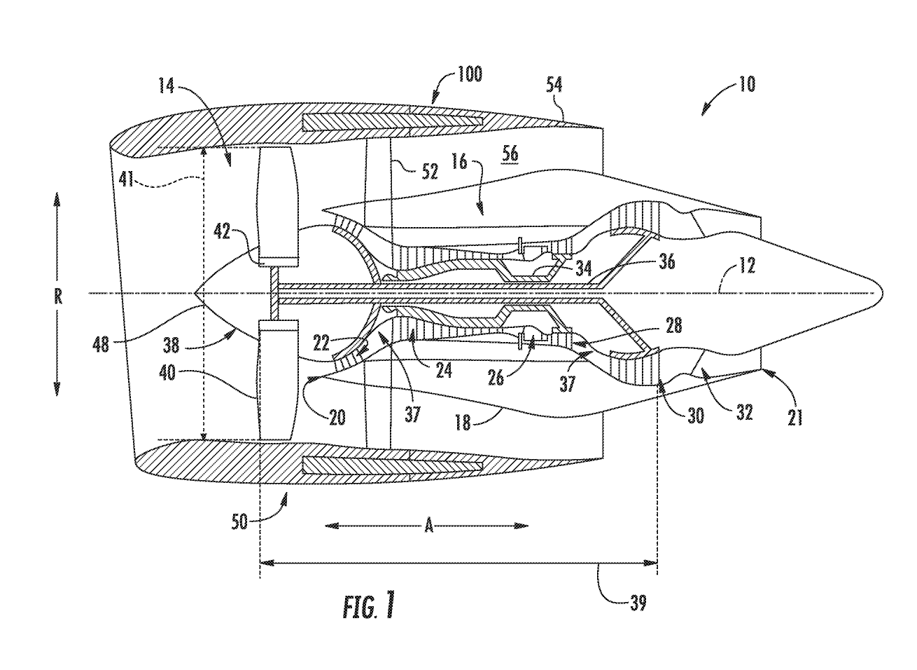

Referring now to the drawings, wherein identical numerals indicate the same elements throughout the figures, FIG. 1 is a schematic cross-sectional view of a gas turbine engine in accordance with an exemplary embodiment of the present disclosure. More particularly, for the embodiment of FIG. 1, the gas turbine engine is a high-bypass turbofan jet engine 10, referred to herein as “turbofan engine 10.” As shown in FIG. 1, the turbofan engine 10 defines an axial direction A (extending parallel to a longitudinal centerline 12 provided for reference) and a radial direction R. The turbofan engine 10 may also define a circumferential direction (not shown) extending circumferentially about the axial direction A. In general, the turbofan 10 includes a fan section 14 and a core turbine engine 16 disposed downstream from the fan section 14.

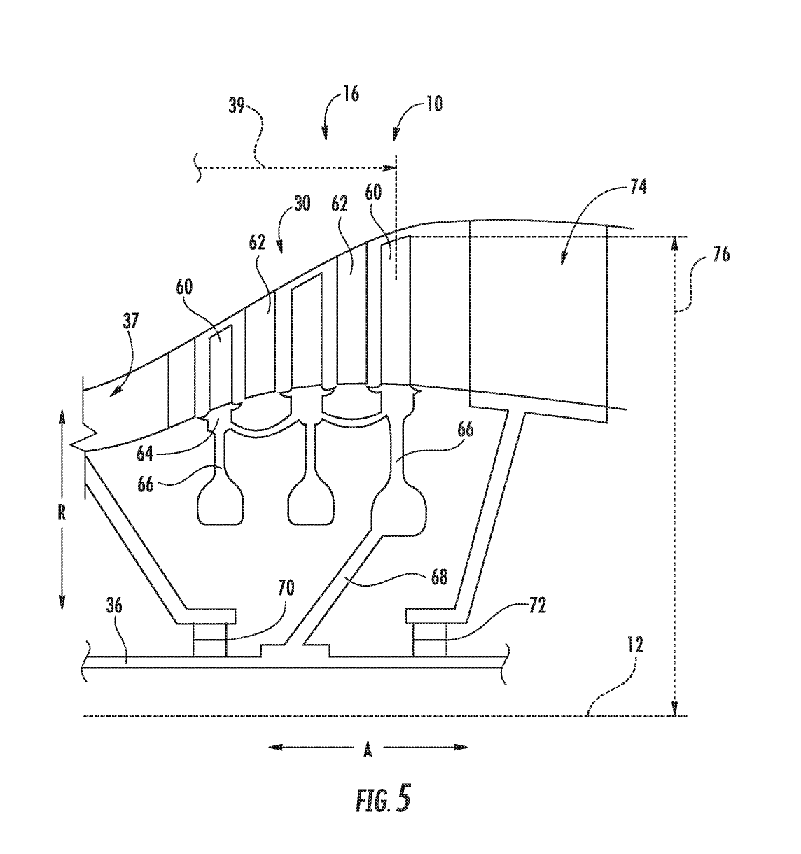

The exemplary core turbine engine 16 depicted is generally enclosed within a substantially tubular outer casing 18 that defines an annular inlet 20 and an annular exhaust 21. The outer casing 18 encases, in serial flow relationship, a compressor section including a booster or low pressure (LP) compressor 22 and a high pressure (HP) compressor 24; a combustion section 26; a turbine section including a high pressure (HP) turbine 28 and a low pressure (LP) turbine 30; and a jet exhaust nozzle section 32. A high pressure (HP) shaft or spool 34 drivingly connects the HP turbine 28 to the HP compressor 24. A low pressure (LP) shaft or spool 36 drivingly connects the LP turbine 30 to the LP compressor 22. The compressor section, combustion section 26, turbine section, and nozzle section 32 together define a core air flowpath 37 therethrough. It will also be appreciated, that the turbofan engine 10 defines a turbomachinery length 39. The turbomachinery length 39 refers to a length along the axial direction A from a leading edge of the fan 38 to a centerline of an aft-most stage LP turbine rotor blade 60 of the LP turbine 30 (see FIG. 5). It will be appreciated that the leading edge of the fan 38 is for the purposes of this application located at an intersection between a leading edge of the plurality of fan blades 40 and the rotatable front hub 48.

For the embodiment depicted, the fan section 14 includes a fixed pitch fan 38 having a plurality of fan blades 40. The fan 38, and more specifically, the plurality of fan blades 40 of the fan 38, define a fan diameter 41 along the radial direction R. The fan blades 40 are each attached to a disk 42, with the fan blades 40 and disk 42 together rotatable about the longitudinal axis 12 by the LP shaft 36. For the embodiment depicted, the turbofan engine 10 is a direct drive turbofan engine, such that the LP shaft 36 drives the fan 38 of the fan section 14 directly, without use of a reduction gearbox. However, in other exemplary embodiments of the present disclosure, the turbofan engine 10 may include a reduction gearbox, in which case the LP shaft 36 may drive the fan 38 of the fan section 14 across the gearbox.

Referring still to the exemplary embodiment of FIG. 1, the disk 42 is covered by rotatable front hub 48 aerodynamically contoured to promote an airflow through the plurality of fan blades 40. Additionally, the exemplary turbofan engine 10 includes an annular nacelle assembly 50 that circumferentially surrounds the fan 38 and/or at least a portion of the core turbine engine 16. For the embodiment depicted, the nacelle assembly 50 is supported relative to the core turbine engine 16 by a plurality of circumferentially-spaced outlet guide vanes 52. Moreover, a downstream section 54 of the nacelle assembly 50 extends over an outer portion of the casing 18 so as to define a bypass airflow passage 56 therebetween. The ratio between a first portion of air through the bypass airflow passage 56 and a second portion of air through the inlet 20 of the core turbine engine 16, and through the core air flowpath 37, is commonly known as a bypass ratio. For the present disclosure, the turbofan engine 10 defines a bypass ratio greater than or equal to five (5). For example, in certain exemplary embodiments, the bypass ratio may be greater than or equal to seven (7).

Additionally, as will be discussed in greater detail with reference to the exemplary embodiments below, the nacelle assembly 50 includes a thrust reverser system 100, which is depicted in a fully stowed position.

It should be appreciated, however, that the exemplary turbofan engine 10 depicted in FIG. 1 is by way of example only, and that in other exemplary embodiments, the turbofan engine 10 may have any other suitable configuration, including, for example, any other suitable number of shafts or spools.

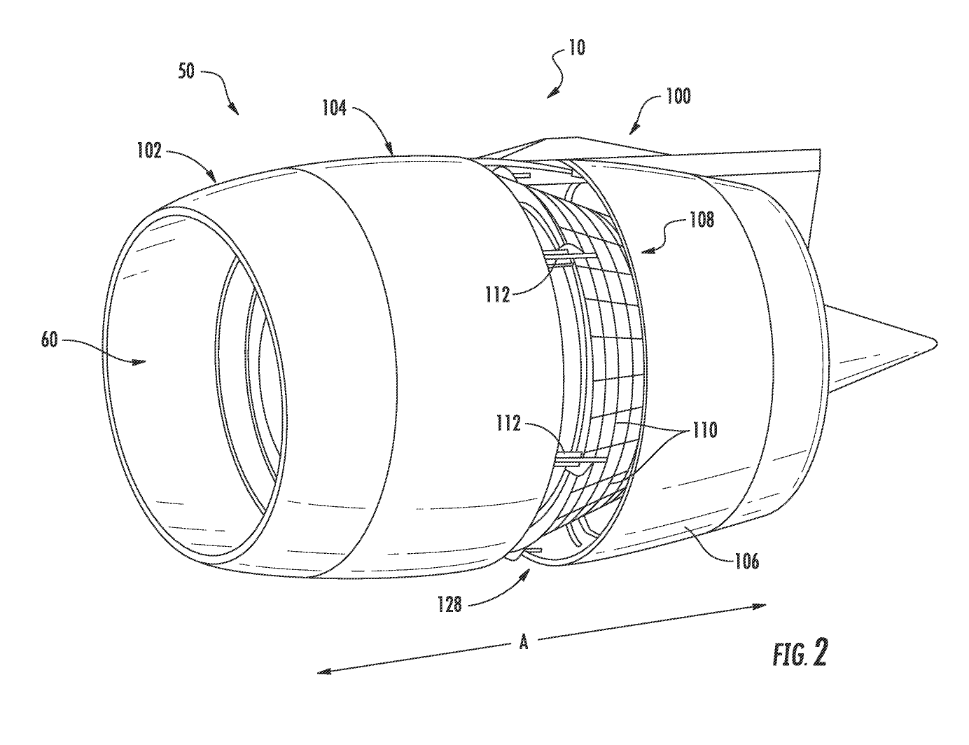

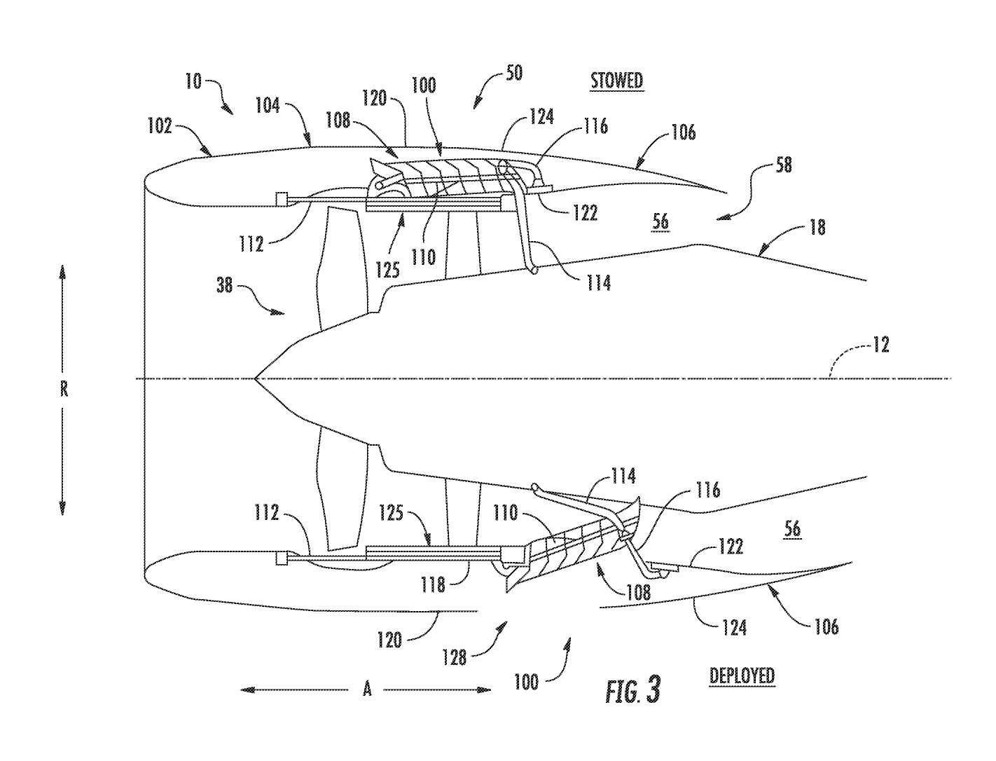

Referring now to FIGS. 2 and 3 a turbofan engine 10 in accordance with another exemplary embodiment of the present disclosure is provided. The exemplary turbofan engine 10 depicted in FIGS. 2 and 3 includes a thrust reverser system 100 in accordance with an exemplary embodiment of the present disclosure. Specifically, FIG. 2 provides a perspective view of the exemplary turbofan engine 10 with the thrust reverser system 100 in a fully deployed position; and FIG. 3 provides a cross-sectional schematic view of the exemplary turbofan engine 10 along an axial direction A, a top half of which depicting the thrust reverser system 100 in a fully stowed position and a bottom half of which depicting the thrust reverser system 100 in a fully deployed position. The exemplary turbofan engine 10 of FIGS. 2 and 3 may be configured in substantially the same manner as the exemplary turbofan engine 10 of FIG. 1. Accordingly, the same numbering may refer to the same or functionally equivalent components.

As depicted, a nacelle assembly 50 of the turbofan engine 10 generally includes an inlet assembly 102, a fan cowl 104, and the thrust reverser system 100. The inlet assembly 102 is positioned at a forward end of the nacelle assembly 50 and the fan cowl 104 is positioned aft of the inlet assembly 102 and at least partially surrounds the fan 38. The thrust reverser system 100 is, in turn, positioned substantially completely within the fan cowl 104 when in the stowed position. As is depicted, an outer casing 18 of a core 16 defines a radially inward boundary of a bypass passage 56 and the nacelle assembly 50 defines a radially outward boundary of the bypass passage 56. Bypass air of the engine 10 passes through the bypass passage 56 and exits through a fan exit nozzle 58 during certain operations.

The thrust reverser system 100 of FIGS. 2 and 3 includes a translating cowl (transcowl) 106 slidably mounted to the fan cowl 104, and a cascade system 108. As evident from FIG. 2, the transcowl 106 is the aft-most section of the nacelle assembly 50, located aft of the fan cowl 104 and circumscribing the outer casing 18 of the core 16. When in a fully deployed position (see FIG. 2 and bottom portion of FIG. 3), the cascade system 108 is also located at least partially aft of the fan cowl 104 and circumscribes the outer casing 18 of the core 16. By contrast, when in a fully stowed position (see top portion of FIG. 3) the cascade system 108 is stowed substantially completely within the fan cowl 104. Notably, as the cascade system 108 is stowed substantially completely within the fan cowl 104 when in the fully stowed position (and slides/translates into the deployed position generally along the axial direction A), inclusion of the cascade system 108 may allow for a reduced overall axial length of the nacelle assembly 50.

The cascade system 108 depicted is formed of, and includes, a plurality of individual cascade segments 110 that are circumferentially spaced around a circumference of the nacelle assembly 50. As evident from FIG. 3, the segments 110 of the cascade system 108 are adapted to deploy from a fully stowed position, shown in the upper half of FIG. 3, to a fully deployed position shown in the lower half of each of FIG. 3. For the embodiment depicted, the transcowl 106 and cascade system 108 are adapted to be translated in unison in an aft direction of the engine 10, generally along the axial direction A, when the thrust reverser system 100 is moved from the fully stowed position to the fully deployed position (i.e., deployed). More particularly, to deploy the cascade system 108 into the bypass passage 56, the transcowl 106 is moved aftwardly from the fan cowl 104 generally along the axial direction A and the cascade system 108 is translated and pivoted, causing a flow of bypass air within the passage 56 to be diverted through the deployed cascade system 108 to provide a thrust reversal effect. For this purpose, FIGS. 2 and 3 represent the cascade segments 110 as pivotally coupled to the nacelle assembly 50 through respective actuators 112 mounted to the nacelle assembly 50. The actuators 112 are configured to move the thrust reverser system 100 from the fully stowed position to the fully deployed position. The actuators 112 can be of any suitable type and can be driven by, e.g., pneumatic, hydraulic, or electric motors. Additionally, the cascade systems 110 are depicted being coupled to a fixed structure of the nacelle assembly 50 with guided connections 125. Further, FIG. 3 represents the cascade segments 110 as pivotally coupled to the outer casing 18 of the core 16 with drag links 114, and represent the transcowl 106 as pivotally coupled to the cascade segments 110 through links 116 for translation therewith.

Translation of the cascade system 108 and transcowl 106 in the aft direction along the axial direction A causes the cascade segments 110 to be deployed into the bypass passage 56 in a manner represented in FIG. 3. From the figures it can be appreciated that, when fully stowed, the cascade segments 110 are enclosed and completely concealed between inner and outer engine fan cases 118, 120 of the fan cowl 104, and, for the embodiment depicted, the inner and outer walls 122, 124 of the transcowl 106. Accordingly, when the thrust reverser system 100 is fully stowed, the inner engine fan case 118 and the inner wall 122 of the transcowl 106 define a portion of the radially outer flow surface of the bypass passage 56 and completely separate the cascade system 108 from the duct 56.

By contrast, when moved to the fully deployed position, the cascade segments 110 of the thrust reverser system 100 may, but are not required to, extend entirely across a radial width of the duct 56 so that its aft end 126 contacts, or nearly contacts, the outer casing 18 of the core 16. As represented in FIG. 3, as bypassed air within the duct 56 encounters the cascade system 108, the air is diverted by grid openings in the segments 110 and expelled through a circumferential opening 128 defined between the inner and outer engine fan cases 118, 120 and the inner and outer walls 122, 124 of the transcowl 106. As depicted in FIG. 3, each segment 110 can be equipped with an extension that promotes the capture of air flowing along the outer surface of the outer casing 18 of the core 16.

As evident from the above, the embodiment depicted incorporates to some extent a conventional role of a blocker door function into the cascade system 108, and does so by adding rotation to the translating motion of cascades. To serve in this role, each cascade segment 110 must have a sufficient length and be sufficiently angled downward to, in certain embodiments, completely block the fan bypass passage 56.

It should be appreciated, however, that the exemplary thrust reverser system 100 depicted is provided by way of example only, and that in other exemplary embodiments, the thrust reverser system 100 may have any other suitable configuration. For example, while the embodiment of FIGS. 2 and 3 depict each cascade segment 110 as equipped with two different links 114 and 116 rotatably coupled near the aft end 126 of each segment 110 to impart and control the rotational movement of the segment 110 during deployment, in other exemplary embodiments the link 114 may be eliminated in order to further decrease aerodynamic drag and other flow perturbations that can cause aerodynamic or acoustic inefficiencies.

Additionally, it should be appreciated that the translational-rotational motion of the cascade segments 110 are not dependent on any particular type of cascade design, aside from the requirement that the cascade system 108 is capable of turning the air flow within the bypass passage 56. For example, in still other embodiments, the thrust reverser system 100 may not include either of the links 114, 116 shown, and instead may, e.g., rely on a geometry of the cascade system 108 and a kinematic deployment system.

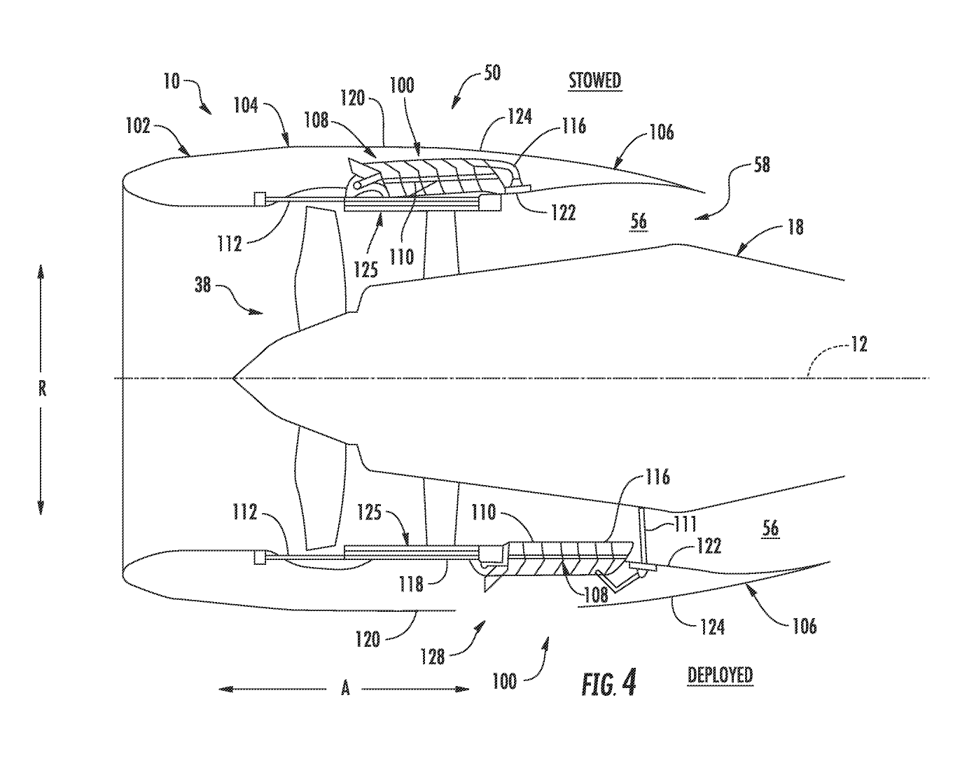

Furthermore, although for the embodiments of FIGS. 2 and 3, the plurality of cascade segments 110 are configured to translate generally along the axial direction A and further to rotate inwardly along the radial direction R as they are moved from the fully stowed position to the fully deployed position, in other exemplary embodiments of the present disclosure, the plurality of cascade segments 110 may not be configured to pivot or rotate. For example, referring now to FIG. 4, a cross-sectional schematic view of a turbofan engine 10 in accordance with another exemplary embodiment is provided. Specifically, the exemplary embodiment of FIG. 4 depicts at a top half a thrust reverser system 100 in accordance with another exemplary embodiment in a fully stowed position and at a bottom half the exemplary thrust reverser system 100 in a fully deployed position. The turbofan engine 10 and thrust reverser system 100 may be configured in substantially the same manner as the turbofan engine 10 and thrust reverser system 100 of FIG. 3. However, for the embodiment of FIG. 4, the plurality of cascade segments 110 simply translate generally along the axial direction A between a fully stowed position and a fully deployed position, and one or more blocker doors 111, or in other embodiments some other structure (not shown), are deployed within the bypass passage 56 to divert airflow from the bypass passage 56 through the cascade segments 110 to achieve a desired thrust reversal effect.

Referring now to FIG. 5, a close-up, schematic view of an aft end of the core 16 of the exemplary turbofan engine 10 of FIG. 1 is provided. Specifically, FIG. 5 provides a close-up, schematic view of the LP turbine 30 of the turbine section of the exemplary turbofan engine 10 of FIG. 1.

As is depicted, the LP turbine 30 generally includes alternating stages of LP turbine rotor blades 60 and LP turbine stator vanes 62. Each of the plurality LP turbine rotor blades 60 are attached at a base 64 to a respective LP turbine rotor 66. The LP turbine rotor 66 of each stage of LP turbine rotor blades 60 is connected to an adjacent LP turbine rotor 66—the plurality of LP turbine rotors 66 further connected to the LP shaft 36 through an LP shaft extension 68. Accordingly, a flow of combustion gasses through the LP turbine 30 rotates the plurality of LP turbine rotor blades 60 and LP turbine rotors 66, which in turn rotates the LP shaft 36. The LP turbine 30 further includes a plurality of stages of LP turbine stator vanes 62, each of which attached to the casing 18 of the core turbine engine 16. As will be appreciated, the stages of LP turbine stator vanes 62 may increase an efficiency of the LP turbine 30.

Briefly, it will further be appreciated, that for the embodiment depicted, the LP shaft 36 is supported by a first, forward bearing 70 and a second, aft bearing 72. The forward bearing 70 supports the LP shaft 36 from a location forward of the extension member 68 of the LP shaft 36, while the aft bearing 72 supports the LP shaft 36 from a location aft of the extension member 68 of the LP shaft 36. Further, the forward bearing 70 is configured to support the LP shaft 36 through a turbine center frame (not shown) and the aft bearing 72 is configured to support the LP shaft 36 through a turbine rear frame 74. Additionally, for the embodiment depicted, the forward and aft bearings 70, 72 are each depicted as roller bearings. However, in other exemplary embodiments, one or both of the forward and aft bearings 70, 72 may alternatively be configured as any other suitable bearing, such as a ball bearing, a tapered roller bearing, etc. Further, it should be appreciated that in still other exemplary embodiments, the LP shaft 36 may instead be supported in any other suitable manner. For example, in other exemplary embodiments, both the forward and aft bearings 70, 72 may be positioned forward of the extension member 68 of the LP shaft 36, or alternatively, may both be positioned aft of the extension member 68 of the LP shaft 36.

Referring still to FIG. 5, it will be appreciated, that the LP turbine 30 is configured as a compact LP turbine 30. For example, the LP turbine 30 comprises six (6) or less stages of LP turbine rotor blades 60, such as three (3) or less stages of LP turbine rotor blades 60. More specifically, for the embodiment depicted, the LP turbine 30 comprises three (3) stages of LP turbine rotor blades 60. Additionally, the LP turbine 30 defines an exit diameter 76 along the radial direction R (i.e., a diameter of the aft-most LP turbine rotor blades 60 along the radial direction R). For the size of turbofan engine 10 within which the LP turbine 30 is configured, the exit diameter 76 of the LP turbine 30 is relatively small. Additionally an overall turbomachinery length 39 (measured to the centerline of the aftmost LP turbine rotor blade 60 of the LP turbine 30) is also relatively small as compared to the fan diameter 41.

More particularly, referring now back also to FIG. 1, the turbofan engine 10 defines a ratio of the exit diameter 76 of the LP turbine 30 to the fan diameter 41 of the fan 38 less than 0.5. For example, in certain exemplary embodiments, the turbofan engine 10 may define a ratio of the exit diameter 76 of the LP turbine 30 to the fan diameter 41 of the fan 38 less than 0.45, such as less than 0.4. Further, for the turbofan engine 10 depicted, a ratio of the turbomachinery length 39 of the turbofan engine 10 to the fan diameter 41 of the fan 38 may be less than 1.6. For example, the ratio of the turbomachinery length 39 of the turbofan engine 10 to the fan diameter 41 of the fan 38 may be less than 1.5, such as less than 1.4, such as less than 1.3.

Furthermore, the turbofan engine 10 depicted is configured as a relatively large turbofan engine 10. For example, the turbofan engine 10 may be configured to generate at least about 10,000 pounds of thrust during operation, such as at least about 15,000 pounds of thrust during operation, such as at least about 20,000 pounds of thrust during operation. Inclusion of a compact LP turbine and a translating cascade thrust reverser with a turbofan engine configured in accordance with one or more exemplary embodiments the present disclosure may allow for a reduction in overall length and size of the turbofan engine, which in turn, may allow for the turbofan engine to operate more efficiently and to burn less fuel.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A gas turbine engine defining an axial direction, the gas turbine engine comprising:
a fan defining a fan diameter;
a nacelle assembly enclosing the fan and comprising a thrust reverser system, the thrust reverser system comprising one or more cascade segments configured to translate at least partially along the axial direction of the gas turbine engine; and
a core operable with the fan and at least partially enclosed by the nacelle, the core comprising a turbine section, the turbine section comprising a high pressure turbine and a low pressure turbine, the low pressure turbine defining an exit diameter, and a ratio of the exit diameter of the low pressure turbine to the fan diameter of the fan being less than 0.5.

2. The gas turbine engine of claim 1, wherein the ratio of the exit diameter of the low pressure turbine to the fan diameter of the fan is less than 0.45.

3. The gas turbine engine of claim 1, wherein the ratio of the exit diameter of the low pressure turbine to the fan diameter of the fan is less than 0.4.

4. The gas turbine engine of claim 1, wherein the low pressure turbine comprises six or less stages.

5. The gas turbine engine of claim 1, wherein the low pressure turbine comprises three or less stages.

6. The gas turbine engine of claim 1, wherein the one or more cascade segments translate between a stowed position and a deployed position generally along the axial direction, and wherein the thrust reverser system is configured to generate a reverse thrust when the one or more cascade segments are in the deployed position.

7. The gas turbine engine of claim 6, wherein the nacelle comprises a fan cowl at least partially surrounding the fan, and wherein the one or more cascade segments are substantially completely positioned within the fan cowl when in the stowed position.

8. The gas turbine engine of claim 1, wherein the gas turbine engine defines a turbomachinery length, wherein a ratio of the fan diameter to the turbomachinery length is less than 1.5.

9. The gas turbine engine of claim 1, wherein the gas turbine engine is configured to generate at least about 10,000 pounds of thrust during operation.

10. The gas turbine engine of claim 1, wherein the gas turbine engine defines a bypass ratio greater than or equal to five (5).

11. A gas turbine engine defining an axial direction, the gas turbine engine comprising:
a fan comprising a plurality of fan blades and defining a fan diameter;
a nacelle assembly enclosing the fan and comprising a thrust reverser system, the thrust reverser system comprising one or more cascade segments configured to translate at least partially along the axial direction of the gas turbine engine; and
a core operable with the fan and at least partially enclosed by the nacelle, the core comprising a low pressure turbine having an aft-most stage of rotor blades, the gas turbine engine defining a turbomachinery length from the fan blades of the fan to the aft-most stage of rotor blades of the low pressure turbine, a ratio of the turbomachinery length to the fan diameter being less than 1.5.

12. The gas turbine engine of claim 11, wherein the core comprises a turbine section, wherein the low pressure turbine defines an exit diameter, and wherein a ratio of the exit diameter of the low pressure turbine to the fan diameter of the fan is less than 0.5.

13. The gas turbine engine of claim 12, wherein the ratio of the exit diameter of the low pressure turbine to the fan diameter of the fan is less than 0.45.

14. The gas turbine engine of claim 12, wherein the ratio of the exit diameter of the low pressure turbine to the fan diameter of the fan is less than 0.4.

15. The gas turbine engine of claim 11, wherein the low pressure turbine comprises six or less stages.

16. The gas turbine engine of claim 11, wherein the low pressure turbine comprises three or less stages.

17. The gas turbine engine of claim 11, wherein the one or more cascade segments translate between a stowed position and a deployed position generally along the axial direction, and wherein the thrust reverser system is configured to generate a reverse thrust when the one or more cascade segments are in the deployed position.

18. The gas turbine engine of claim 17, wherein the nacelle comprises a fan case at least partially surrounding the fan, and wherein the one or more cascade segments are substantially completely positioned over the fan case when in the stowed position.

19. The gas turbine engine of claim 11, wherein the gas turbine engine is configured to generate at least about 15,000 pounds of thrust during operation.

20. The gas turbine engine of claim 11, wherein the gas turbine engine is configured to generate at least about 20,000 pounds of thrust during operation.
